(19) United States
(12) Patent Application Publication
(10) Pub. No.: US 2002/0163538 A1
(43) Pub. Date: Nov. 7, 2002

(54) Electronic mail guide

(75) Inventor: Yevgeniy Eugene Shteyn, Cupertino, CA (US)

Correspondence Address: Michael E. Schmitt, Corporate Patent Counsel, U.S. Philips Corporation, 580 White Plains Road, Tarrytown, NY, 10591, US

(73) Assignee: Koninklijke Philips Electronics N.V.

(21) Appl. No.: 09/851,487

(22) Filed: May 7, 2001

(51) Int. Cl. G06F 3/00

(52) U.S. Cl. 345/752

(57) ABSTRACT

Electronic email or voicemail messages are mapped onto personalized graphical representations for providing a concise GUI.

### FIELD OF THE INVENTION

The invention relates to processing and presentation of electronic content information and specifically to a user interface and method to facilitate user selection incoming electronic mail messages.

### BACKGROUND OF THE INVENTION

As an example of electronic document distribution system, consider an email system. Email enables users to exchange computer messages via a data network such as the public Internet and the private AOL. The email protocol is a component of the Transport Control Protocol/Internet Protocol (TCP/IP). Most online services and Internet Service Providers (ISPs) offer email, and most of them also support gateways for exchanging mail with users of other systems. Email messages typically comprise text, and can have text, graphics, video, sound files, web pages, etc., as attachments to or embedded within the email body. In recent years, the use of email has exploded. By some estimates, there are now 25 million email users sending 15 billion messages per year.

Another example of an electronic messaging system is SMS. Short Message Service (SMS) is the ability to send and receive text messages to and from mobile telephones. The text can comprise words, numbers or an alphanumeric combination. SMS was created as part of the GSM Phase 1 standard. The GSM Association (www.gsm.org) reports 15 billion SMS messages currently being sent per month

Yet another example of an electronic messaging system is instant messaging, which is a type of communications service that enables the user to create a private chat room with another individual. Typically, the instant messaging system alerts the user whenever another individual on his/her private list is online. The user can then initiate a chat session with that particular individual. There are several competing instant messaging systems. For example, AOL Instant Messenger is a free software program that lets users receive instant alerts, send instant messages, share photos, pictures and sounds, chat with friends and family or people with similar interests, etc.

The growing popularity of these and other electronic messaging systems has had some negative effects. One of the problems is electronic spam, which is usually defined as electronic junk mail or junk newsgroup postings. In addition to wasting people's time with unwanted email, spam also eats up a lot of network bandwidth. Consequently, there are many organizations, as well as individuals, who have taken it upon themselves to fight spam with a variety of techniques. An example of an anti-spam technique is discussed in U.S. Pat. No. 6,023,723 titled: “Method and system for filtering unwanted junk email utilizing a plurality of filtering mechanisms”. According to this technique, a first filter is based on a list of email addresses or character strings, which the user does not wish to receive. A second filter is provided including names and character strings, which the user wishes to receive. Any email with an address or string contained in the first filter will be automatically eliminated from the user's system. Any email with an address or string contained in the second filter will automatically be sent to the user's “In Box”. Any email not provided in either of the filter lists is sent to a “Waiting Room” for user review.

Another problem is occupational spam, which is a large number of emails usually generated within a business and distributed among workers without proper discretion. According to Gartner's survey of 330 business email users (see http://www.infoworld.com/articles/hn/xml/01/04/19/010419hnspamgartner.xml), in primarily U.S. companies ranging from 20 to 10,000 employees, 42 percent of respondents said that they are flat-out getting to much email, and spend on average of 49 minutes a day just managing it. Gartner initiated the spam study to examine the emergence and emphasis of handheld devices to access email. Although a number of solutions were suggested, e.g., “count to 10 before hitting ‘reply all’—then count to 20, the author of the study admits, that “until people get their email under control, it's going to be very difficult to access email from a handheld device”.

Most specialized email client applications provide a graphical user interface (GUI) to access email messages as well as message filtering capabilities. For example, Netscape Messenger v. 4.61, enables users to create email folders and filters to automatically sort incoming and outgoing messages into a pre-defined location.

Internet service mail.yahoo.com provides a browser-based GUI to access one's email. User emails are stored on the service's server and can be accessed from any HTTP client. The service enables document folder creation, message filtering and some anti-spam capabilities.

### SUMMARY OF THE INVENTION

The inventor has realized that several technical and non-technical trends have impact on the effectiveness of a user interface for an electronic messaging system. The more important ones among these are: a) the increasing number of users with limited computer skills, e.g., children, non-technology workers, etc.; b) the increasing number and variety of GUI enabled communication devices, e.g., mobile phones, PDAs, television receivers, PCs, answering machines, web displays, and others; c) the vast and ever increasing number of electronic documents that require the user's attention and handling. In view of the aforementioned trends, there is a need for simple and intuitive user interfaces to present and enable handling of different types of electronic documents.

An aspect of this invention addresses enhancing the ease of access to electronic information, especially for GUI enabled devices and software. A further aspect of this invention addresses enhancing efficiency of user control over electronic communications.

Therefore, the invention relates a system for mapping an information aspect or a semantic aspect of an electronic message onto a graphical representation. The mapping is preferably user-programmable. The system comprises, for example, an email processing system, a telephone, an EPG processing system. The user is given access to the message through its graphical representations. The graphical representations enable quick scanning for selection as opposed to having to read texts, as the graphical representations represent information in a very dense format.

The invention relates to a method for providing access to an electronic message, the method comprising mapping information aspects or semantic content of the message onto at least one graphical representation. The invention also relates to a database with graphical representation for being mapped onto semantic or informational aspects of an electronic document. The invention further relates to a representation of an electronic message resulting from a mapping of the document onto a graphical representation, and to software enabling to map an electronic document onto one or more graphic representations.

The invention provides an “Electronic Mail Guide” (EMG) feature that allows a user to access graphically coded electronic messages in an intuitive manner consistent with an Electronic Program Guide (EPG) or Electronic Content Guide (ECG). Within this context, reference is made to U.S. Ser. No. 09/568,932 (attorney docket US 000106) filed May 11, 2000 for Eugene Shteyn and Rudy Roth for ELECTRONIC CONTENT GUIDE RENDERS CONTENT RESOURCES TRANSPARENT, herein incorporated by reference. This document relates to a data management system on a home network. The system collects data that is descriptive of content information available at various resources on the network, including an electronic program guide (EPG). The data is combined in a single menu to enable the user to select from the content, regardless of the resource.

A graphic attribute of an electronic message within the EMG represents an information dimension of the message, such as topic, sender, type of an attachment, time, sender's gender and others. A graphic attribute is, for example, defined by the user or is selected from a known set of attributes, which hereafter is referred to as a representation palette. An electronic message is represented within the EMG by such a graphic attribute or a combination of such attributes. An information dimension, e.g., one that is common among multiple electronic messages, can be used as a logical dimension of the EMG. The user is enabled to navigate along the dimensions of the EMG to browse messages. An EMG selection and/or filtering means, which thereafter is referred as a control palette, can be associated with the EMG. The control palette comprises controls, e.g., buttons, representing informational dimensions. By affecting the controls, user is enabled to select and/or filter messages presented in the EMG. The control palette can be implemented as a virtual tool, e.g., a GUI element, or a physical tool, e.g., buttons on remote control device, or a combination of both. The system is enabled to provide alternative graphic representations of information dimensions for interface devices with different UI capabilities, e.g., a gray-scale pattern instead of a color for a palmtop PDA. The user is enabled to import graphic and/or control palettes representing particular information dimensions. The user is also enabled to further customize palettes by changing his/her graphical, informational and control attributes.

### BRIEF DESCRIPTION OF THE DRAWING

The invention is explained below, by way of example and with reference to the accompanying drawing, wherein:

FIG. 1 illustrates an example schematic diagram of an EMG interface in the invention;

FIG. 2 illustrates another example schematic diagram for an EMG interface 100 for a handheld wireless messaging appliance 280 for young children;

FIG. 3 illustrates an example schematic diagram of a system that enables an EMG in the invention; and

FIG. 4 is a block diagram of a system in the invention.

Throughout the drawing, same reference numerals indicate same or corresponding features.

### DETAILED EMBODIMENTS

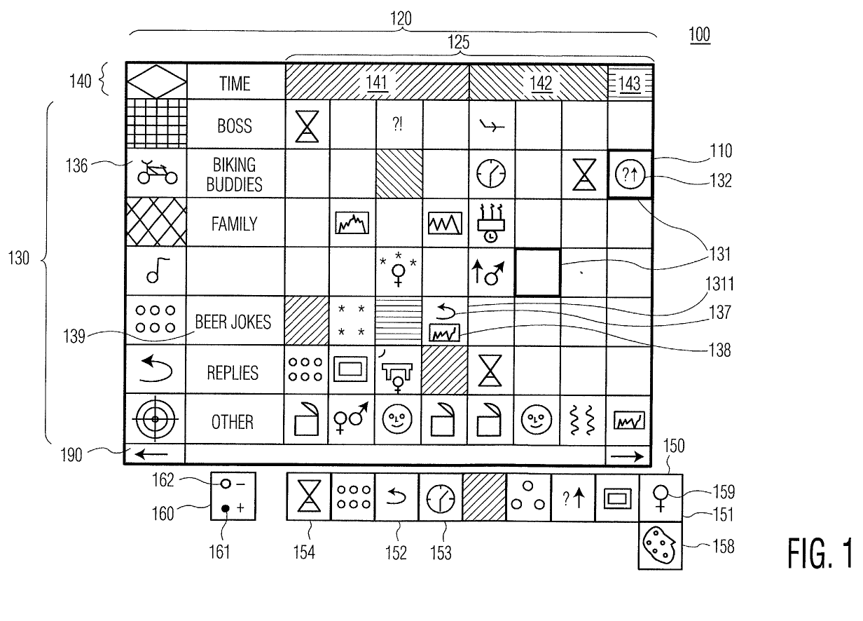

FIG. 1 illustrates an example schematic diagram of an EMG interface 100 in the invention. Interface 100 includes a presentation grid 110, an optional control palette 150, a scroll bar 190 and an optional logic switch 160. Presentation grid 110 contains one or more theme identifying columns 120, an optional title row 140, message rows 130, and message cells such as cells 131. Message cells 131 can be arranged in message columns 125. Cells 141, 142, 143 in title row 140 may span more than one message cell or column. Each cell 131 contains a graphic representation, e.g., representation 132, of an electronic message (not shown). A combination of representations can be used within one cell to better represent an electronic message. Therefore, the user is enabled to easily identify the semantics of a message, by looking at the cell 131 and matching it against graphic attributes in the cell and graphic attribute 136 of row 130. For example, representation 132 is defined as a “What's up!” generic attribute of a greeting message, while representation 136 denotes a message sender from the user's biking club. Additionally, cell 141 is of color light blue, which represents time between 8 am to 12 pm, cell 142 is of color yellow, which represents time between 12 pm to 3 pm, and cell 143 is of color light green to represent time between 3 pm and 6 pm. The latter attribute enables user to understand that the message was received (or sent) within a certain time interval. In another example, a combination of graphic attributes 137, 138 in cell 1311 in row 139 enables user to easily understand that it represents a return message with a picture that refers to a beer joke, that was received before 12 pm.

Control palette 150 comprises controls, e.g. buttons 151, 152 and others. The semantics of a button is represented by a graphic attribute 159. The user is enabled to filter messages in EMG 110 by depressing the buttons. For example, by having buttons 151 (from girls), 153 (appointments), 152 (reply messages), 154 (reminders) depressed, the user selects messages that comply with any of the aforementioned semantics associated with the graphic attributes associated with the buttons. Preferably, only the frequently-used buttons are placed on palette 150. The user can access additional defined buttons by pressing a “palette” button 158.

Preferably, a logic palette 160 enables user to select the logic rules that apply to a combination of the buttons. For example, when a radio button 161 is on, the filter uses logical OR to create a message selection criteria. Alternatively, when radio button 162 is on, the filter uses logical AND. Preferably, a row palette 180 enables user to insert or remove rows by depressing buttons 181, 182 and others in a manner consistent with the operation of palette 150.

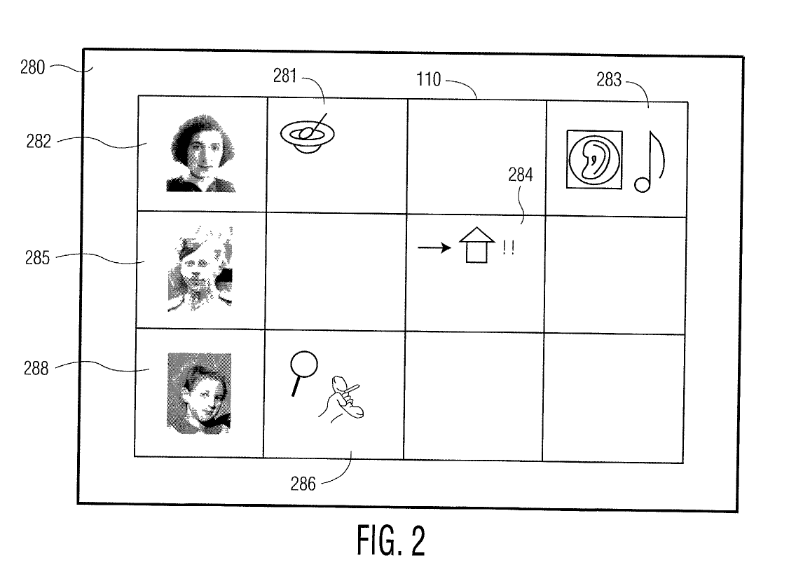

FIG. 2 illustrates example schematic diagram for an EMG interface 100 for a wireless messaging appliance 280 for young children, e.g., worn as a watch or stitched to a sleeve of a jacket. Grid 110 contains message fields, e.g., field 281 with graphic and/or other sensory attributes that do not require any reading abilities. Preferably, the graphics or sensory representation of a message contains non-alphanumeric content, e.g. sound, animation, video, graphics, etc. Control palette 150 of FIG. 1 is implemented as a set of graphically coded physical buttons 151 through 154 embedded in the housing of appliance 280. In the example shown, field 281 is caused to show that dinner (or lunch or breakfast) is ready. The person causing this is the child's mother, whose picture is shown in field 282. Field 283 shows a representation of another message from mother. This message is interpreted as: Listen, here is a nice song for you”. When the child interacts with the EMG, e.g., through a touch screen on device 280, the music file sent by mother is being played out through the loudspeaker (not shown) of device 280. Field 284 shows a representation of another message that is a repeated warning (by way of the two exclamation marks) from father that the child is to come home, and on the double. Father's picture is shown in field 285. Field 286 conveys the message sent by the child's sister 288: “someone is looking for you and left you a call”, etc. Note that different persons may send differently worded messages to device 280 that get mapped onto the same icon. For example, a speech processing system on the home network infers from spoken messages “tell Ben to come home for dinner” and “dinner is ready, Ben is to come home” that the mapping is to be done on the icon displayed in cell 281. Voice recognition software is used to automatically identify the speaker. For a small group of people, discrimination based on voice spectra is relatively simple.

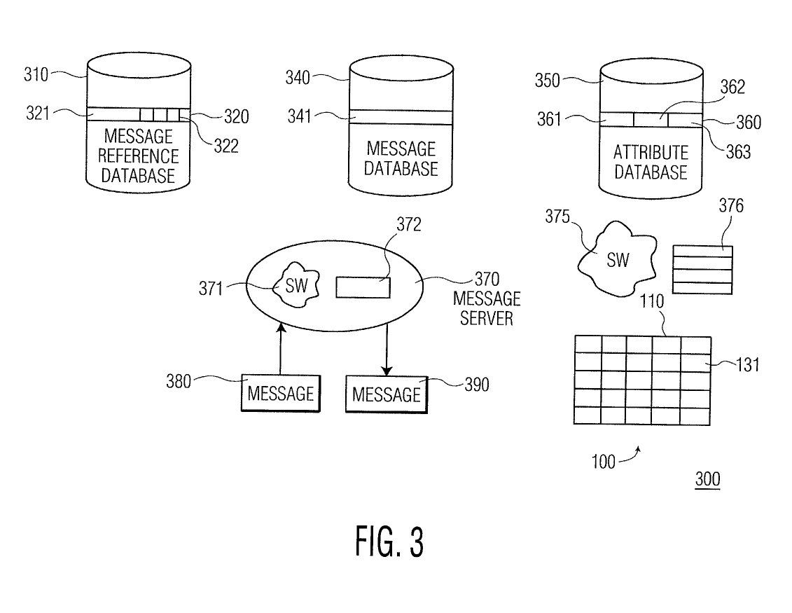

FIG. 3 illustrates an example schematic diagram of a message processing system 300 that enables an EMG in the invention. System 300 contains a message reference database 310, message database 340, and message attribute database 350, and message server 370. Message reference database 310 contains one or more reference records, e.g., record 320. Record 320 comprise message content reference 321 and at least one message attribute 322. Message content database 340 represents the semantic contents 341 of one or more electronic messages. Attribute database 350 contains one or more attribute records 360, which comprise attribute assignment criteria 361, an attribute graphic representation 362 and an attribute identifier (ID) 363. An incoming electronic message 380 and/or an outgoing message 390 is processed on messaging server 370 by filtering software 371. Software 371 utilizes assignment criteria 361 to determine proper attribute IDs for message 380 or 390. This can be accomplished, for example, by automatic feature extraction known from text analysis tools. The contents of the message 380 or 390 is placed into database 340. The message content reference, as well as attributes identified by software 371, are placed in database 310. When the user invokes EMG 100, software 375 uses EMG preferences 376, e.g., as set by the user, including presentation filtering criteria, to form EMG grid interface 110. Software 375 associates message reference 321 and attributes 322 with message cell 131, as well as retrieves appropriate graphic attribute 362. Message reference 321 is used to retrieve the contents 341 when the user clicks on cell 131. Preferably, the user is enabled to modify criteria 361 and graphic attributes 362. A set of attribute records 360 can be distributed and shared by multiple users, e.g., in a corporate network environment, social club, virtual community, etc.

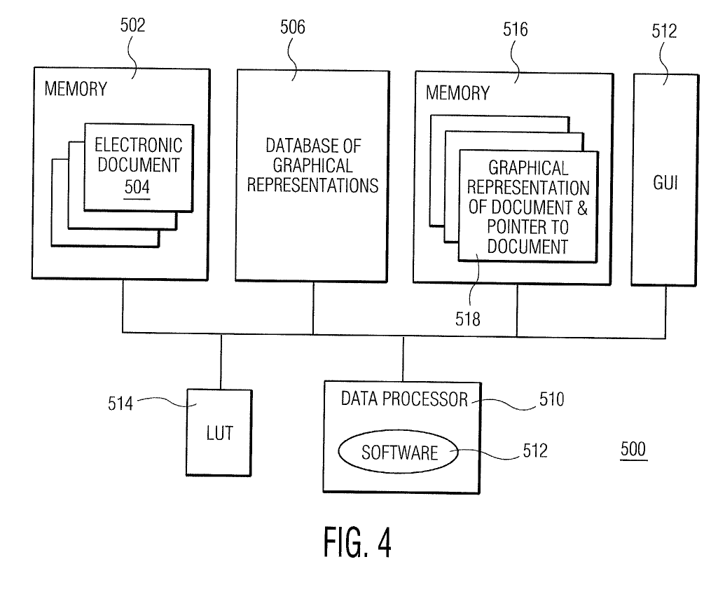

FIG. 4 is a block diagram of an example of a system 500 in the invention. System 500 comprises a memory 502 to store electronic documents 504. System 500 further comprises a database 506 of graphical representations available for graphically representing semantic or other informational aspects of documents 504. Documents 504 are mapped on the reference space formed by the graphical representations in database 506 under software control. To this end, system 500 comprises a data processor 508 and software 510. Software 510 lets the user specify what aspects to look for as input to the mapping process via a GUI 512. These user specifications are stored in a look-up table 514. When a new document is stored in memory 502, processor 510 performs an analysis based on the entries in LUT 514 and maps the new document onto the relevant graphical representation or representations. The new representations are stored in a memory 516 together with a pointer to the associated document. The inventory of memory 502 is graphically represented on GUI 512 by the representation/pointer combinations 518 in memory 516.

Consider following scenarios in communication systems. In a first example, system 500 comprises an email processing functionality. The user specifies processor 510 to map emails from a certain sender onto a specific color or icon available in database 506, and to map emails comprising certain keywords or their semantic equivalents onto another color or graphical representation of database 506. In operational use, GUI 512 gives the user access to an overview of the emails in terms of their graphical representations. One or more colors or icons per email simply convey the relevance of the emails. In another example, system 500 comprises a telephone, e.g., a cellphone. The user specifies that certain caller-IDs are mapped onto certain colors, icons or hatching. If voicemail facilities are present, the recorded messages are time-stamped, and possibly analyzed as to their semantic content. This is certainly feasible if the messages are stored digitally. Accordingly, stored messages can be graphically represented with colors and icons for display on the phone's GUI. An aspect of the invention therefore addresses the translation of caller-ID to color-ID™.

Note that both sender and addressee in an email or voicemail system may determine to use similar graphical representations for similar concepts to be conveyed in their communication. Accordingly, the mapped message, i.e., its graphical representation, may be used either as a precursor to the actual message or independently as a notification in its own. A mobile sender or recipient can then choose, based on the semantics conveyed by the representation whether or not to send or retrieve the original message.

The functionalities of system 500 can be implemented in an apparatus or device (e.g., handheld PDA, STB, cellphone, etc.), or in distributed system such as a data network. An email service, for example, can let the user specify his/her mapping of emails onto graphical representations and carry out the mapping on a dedicated application server. The user is then given access to his/her emails in the conventional way or via the graphical representations. The functionalities also can be at least partly implemented in a software application that analyzes a digitized text or voice message and maps it onto one or more graphical representations. Text analysis software is known from, e.g., search engines. Similarly, the mapping of digitized voice messages can be carried out by the telephone company or other dedicated service. Consider as yet another example an EPG. Typically, the known EPG is represented as a grid, wherein a field is reserved per time slot and per TV channel to display text about a TV program available now or in the near future. Again, the conventional EPG can be mapped onto a cluster of graphical representations, preferably personalized, in order to give the end-user a concise overview of filtered information in a graphical format.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the particular partitioning of functions that is shown in the figures is presented for illustration purposes. Aforementioned Databases, software and EMG interface can be located on the same physical device or can be distributed among multiple devices. Implementations of a database, e.g., relational, object-oriented, are well known in the art and can be easily adjusted to needs of a particular messaging system, depending on message volume, size, etc. Databases, for example, can be combined within one memory area within a home network. On the other hand, a multi-user messaging system would involve multiple databases, servers and multi-tier software applications. These and other system configuration and optimization features will be evident to one of ordinary skill in the art in view of this disclosure, and are included within the scope of the following claims.

Incorporated herein by reference are the following patent documents:

U.S. Ser. No. 09/642,713 (attorney docket US 000213) filed Aug. 21, 2000 for Leila Kaghazian for SELECTIVE SENDING OF PORTIONS OF ELECTRONIC CONTENT. This document relates to enabling a user of a handheld communication device to select in a foreground process portions of an electronic document. In a background process a new document is prepared that comprises the selected portions. The user selects the address for forwarding the new document, and the new document gets sent in a background process.

U.S. Ser. No. 09/464,855 (attorney docket PHA 23,875) filed Dec. 16, 1999 for Willem Bulthuis et al., for HAND-EAR USER INTERFACE FOR HAND-HELD DEVICE. This document relates to a hand-held information processing device, such as a mobile phone. The device has a thumb wheel that lets the user scan a circular array of options. Each respective one of the options is represented by a respective audio output that gets played out when the wheel is turned a notch up or down. This enables the user to select an option with one hand and without having to look at the device. It also allows for a form factor smaller than that of a conventional mobile phone since a keypad is not needed for entering digits to make a call from a personalized directory.

What is claimed is:

1. A system for mapping an electronic message onto a graphical representation.

2. The system of claim 1, wherein the mapping is user-programmable.

3. The system of claim 1, wherein the graphical representation is personalizable.

4. The system of claim 1, comprising an email processing system.

5. The system of claim 1, comprising a telephone.

6. The system of claim 1, operating on an EPG.

7. The system of claim 1, wherein the representation is user-interactive for providing user-access to the message.

8. A communication system using representing an electronic message in a GUI by means of a graphical representation of an information aspect of the message.

9. A method for enabling to represent an electronic message, the method comprising mapping the message onto at least one graphical representation.

10. The method of claim 9, enabling an end-user of the message to specify the mapping.

11. The method of claim 9, enabling an end-user to personalize the representation.

12. The method of claim 9, wherein the electronic message comprises an email.

13. The method of claim 9, wherein the message comprises a voice mail.

14. A database with graphical representations for being associated with an electronic document by mapping the document onto at least one representation.

15. A representation of an electronic message resulting from a mapping of the message onto a graphical representation.

16. A software application for mapping an electronic message on a graphical representation.

17. The application of claim 16, providing user control over the mapping.
